(19) United States
(12) Patent Application Publication
(10) Pub. No.: US 2026/0296116 A1
(43) Pub. Date: Oct. 1, 2026

(54) CENTRAL FRAME SYSTEM FOR A MULTI-SECTION VEHICLE, MULTI-SECTION VEHICLE

(71) Applicant: ATG Autotechnik GmbH, Siek (DE)

(72) Inventor: Michael August, Siek (DE)

(21) Appl. No.: 19/570,647

(22) Filed: Mar. 18, 2026

(30) Foreign Application Priority Data
Mar. 25, 2025 (EP) 25165959.5

(51) Int. Cl. B60D 5/00; B60D 1/62

(52) U.S. Cl. CPC B60D 5/006; B60D 1/62

(57) ABSTRACT

A central frame system for a vehicle articulation arranged between a first car and a second car of a multi-section vehicle, comprising a central frame oriented in a transverse direction and a cable harness extending between the first car and the second car. The central frame surrounds a passage intended for passengers. The cable harness is arranged above the passage. A first leaf spring component holds a first portion of the cable harness, a second leaf spring component holds a second portion of the cable harness. The first leaf spring component and the second leaf spring component are connected to the central frame via a guide lever. The first leaf spring component is connected to the guide lever via a first pivot joint. The second leaf spring component is connected to the guide lever via a second pivot joint. The first pivot axis of the first pivot joint and the second pivot axis of the second pivot joint intersect a vertical longitudinal plane of the central frame system. The invention also relates to a multi-section vehicle.

### BACKGROUND

The invention relates to a central frame system for a multi-section vehicle. The invention also relates to a multi-section vehicle, for example in the form of an articulated bus or of a tram.

Central frame systems can be used in different types of road or rail vehicles in which it is possible for the passengers to pass between the cars of the multi-section vehicle while it is travelling. In order to protect the passengers from environmental influences, the passage between the cars is normally provided with a bellows that surrounds the vehicle articulation.

There are technical functions that apply to several cars of a multi-section vehicle. For example, a driver sitting at the front can actuate a light switch in order to turn on a rear light at the rear end of the vehicle. For this, an electrical cable is required, which extends via the intermediate space between the cars. Further functions require hydraulic lines, air hoses and other supply lines between the cars. In the case of a vehicle driven by an electric battery, the supply lines between the battery and the drive motor can be guided via the intermediate space. Several lines that may relate to different functions can be combined to form a cable harness.

In general, the aim is to arrange the floor intended for passengers as low as possible in order to make it easier for the passengers to board and alight from the vehicle. Above the passengers, more space is available, and for this reason the cable harness is frequently guided above the passage via the intermediate space between two cars.

In order to prevent the cables from hitting the central frame when driving over bumps or in the event of uneven surfaces, it is known practice to provide the cable harness with a cable guide that holds the cable harness relative to the central frame, EP 0 897 337 A1, EP 2 384 913 A1, EP 3 210 803 A1, EP 3 354 495 A1. It has proven to be not very easy to design the cable guide such that the movements in the cable harness that arise during operation of the vehicle can be picked up without excessive mechanical stresses arising within the cable guide.

The invention addresses the problem of presenting a central frame system for a multi-section vehicle and a multi-section vehicle, with which the abovementioned drawbacks can be reduced. Proceeding from the abovementioned prior art, the problem is solved by the features of the independent claims. Advantageous embodiments are specified in the dependent claims.

A central frame system according to the invention for a vehicle articulation arranged between a first car and a second car of a multi-section vehicle comprises a central frame oriented in a transverse direction and a cable harness extending between the first car and the second car. The central frame surrounds a passage intended for passengers. The cable harness is arranged above the passage. A first leaf spring component holds a first portion of the cable harness, a second leaf spring component holds a second portion of the cable harness. The first leaf spring component and the second leaf spring component are connected to the central frame via a guide lever. The first leaf spring component is connected to the guide lever via a first pivot joint. The second leaf spring component is connected to the guide lever via a second pivot joint. The first pivot axis of the first pivot joint and the second pivot axis of the second pivot joint intersect a vertical longitudinal plane of the central frame system.

### SUMMARY

The invention is based on the fact that a cable guide in the form of a leaf spring is helpful for guiding a cable harness along a defined path in the intermediate space between the first car and the second car of a multi-section vehicle. Some of the movements, occurring during operation, between the first car and the second car can be picked up by way of a deformation of the leaf spring. However, it has been found that, in particular in the case of pitching movements, significant stresses can arise within the leaf spring, and these cannot be absorbed sufficiently by the overall system in known solutions (see, for example, EP 3 210 803 A1). If the articulation is arranged below the passage, a pitching movement has the result that a considerable change in distance between the first car and the second car occurs in the upper region of central frame system. Therefore, in the event of pitching movements, undesirably high mechanical stresses can arise in the leaf spring.

The invention proposes guiding the cable harness by means of a first leaf spring component and a second leaf spring component, wherein the two leaf spring components are held via a guide lever relative to the central frame. Since the two leaf spring components are attached to the guide lever via pivot joints, the axes of which are adapted to pitching movements of the vehicle, particular movements that previously had to be picked up by a deformation of the leaf spring component can be picked up within the pivot joints without stress.

Cables within the meaning of the present invention serve to link technical functions of the cars of the multi-section vehicle together. The term cable encompasses all supply lines via which signals or forces are transferred between the cars. The term cable encompasses in particular electrical cables, fibre optic cables, hydraulic lines, air hoses for an air-conditioning installation and heating. In the case of the central frame system according to the invention, a cable harness made up of a plurality of such cables extends via the intermediate space between the two cars adjoining the vehicle articulation.

The two cars may be a front car and a rear car of a two-section vehicle, for example of an articulated bus. It is also possible that, starting from the vehicle articulation, more than one car follows in one or both longitudinal directions. The longitudinal direction encloses a right angle with the central frame. A vertical longitudinal plane is a vertical plane that extends in the longitudinal direction.

The movements that occur between the first car and the second car during operation of the multi-section vehicle are complex. The comprise rotation, pitching, rocking and combinations thereof. The term pitching movement is used for a movement that arises when a multi-section vehicle travels straight ahead over a brow or through a depression.

The pivot axis of the first pivot joint (first pivot axis) may enclose an angle of at least 45°, preferably at least 70° with the vertical longitudinal plane. In particular, the pivot axis of the first pivot joint can extend parallel to the central frame and in a horizontal direction. This corresponds to an orientation in the transverse direction such that the vertical longitudinal plane is intersected at an angle of 90°. The same can apply to the orientation of the pivot axis of the second pivot joint (second pivot axis). The first pivot axis and the second pivot axis may be oriented parallel to one another. The first pivot axis and the second pivot axis may be spaced apart from one another. It is also possible for the first pivot axis and the second pivot axis to be coaxial with one another.

Starting from the central frame, the first leaf spring component may extend in the direction of the first car. The first leaf spring component may have a central end and a peripheral end, wherein the central end is arranged near the central frame and the peripheral end is arranged near the first car. The first pivot joint may be arranged in the region of the central end of the first leaf spring component.

The peripheral end of the first leaf spring component may be attached to the first car. The first leaf spring component may be connected to the first vehicle via a first bracket, wherein the first bracket is attached to an end frame of the first vehicle and protrudes in the direction of the central frame.

The first leaf spring component may be attached to the first car via a third pivot joint. The pivot axis of the third pivot joint (third pivot axis) may have a different orientation from the first pivot axis at the other end of the first leaf spring component. The indication relates to a normal state of the central frame system, in which the first car and the second car stand one behind the other in a straight line in a plane. The angle between the first pivot axis and the third pivot axis may be greater than 45°, preferably greater than 70°, and in particular be 90°. The third pivot axis may extend parallel to the vertical longitudinal plane. The third pivot axis may be oriented vertically in the normal state of the vehicle.

The features mentioned for the first leaf spring component can also be realized individually or in combination in the second leaf spring component. The peripheral end of the second leaf spring component may be attached to the second vehicle via a fourth pivot joint. The pivot axis of the fourth pivot joint (fourth pivot axis) may enclose an angle of at least 45°, preferably an angle of at least 70°, more preferably an angle of 90° with the second pivot axis.

Since the first leaf spring component and the second leaf spring component are mounted via pivot joints at both of their ends, the various movements that arise between the first car and the second car during operation of the vehicle can be picked up largely without stress within the pivot joints. Mechanical stresses that arise in the leaf spring components are reduced further.

The central end of the first leaf spring component may be arranged at a short distance from the central end of the second leaf spring component. The distance may, for example, be less than 20 cm, preferably less than 10 cm, more preferably less than 5 cm. The first pivot joint and the second pivot joint can thus be arranged such that the central end of the first leaf spring component is aligned with the central end of the second leaf spring component. The first leaf spring component and the second leaf spring component may jointly span a curved path in the intermediate space between the first car and the second car.

Each leaf spring component may comprise one or more supporting elements in order to hold the cable harness relative to the respective leaf spring component. In this way, the cable harness can be held such that, in the intermediate space between the first car and the second car, it follows substantially the path that is defined by the leaf spring component. The distance between the supporting elements can thus be dimensioned such that the cable harness can bridge the path between two adjacent supporting elements by way of its inherent stability.

The term leaf spring is applied to an elongate element that can be slightly deformed elastically transversely to its longitudinal direction in one direction and can be elastically deformed with more difficulty in another direction. The first leaf spring component and the second leaf spring component can thus be oriented such that they present less resistance to deformations within a horizontal plane than to deformations that pass out of the horizontal plane.

The direction in which the central end of the first leaf spring component extends towards the first pivot joint can enclose an angle of at least 45°, preferably an angle of at least 70°, with the direction in which the peripheral end of the first leaf spring component extends towards the third pivot joint. The indications relate to an angle within a horizontal plane and to the normal state of the multi-section vehicle. The same can apply to the central end and the peripheral end of the second leaf spring component.

The guide lever may comprise a joint holder, to which the first pivot joint and the second pivot joint are attached. The joint holder may be attached to the lever part of the guide lever via a fifth pivot joint. The pivot axis of the fifth pivot joint (fifth pivot axis) may be oriented parallel to the first pivot axis and/or to the second pivot axis. The numbering of pivot joints and pivot axes serves for distinguishing purposes and does not provide any information about the total number of elements that are present.

The guide lever may be mounted on a linear guide, which allows the guide lever to move relative to the central frame. The linear guide may allow a movement in the direction of the central frame and thus in the transverse direction of the multi-section vehicle. The guide lever may additionally or alternatively be mounted pivotably relative to the central frame. In particular, a pivoting movement can be allowed, the axis of which is oriented parallel to the first pivot axis and/or to the second pivot axis. The pivoting range may extend through at least +/−10°, preferably through at least +/−20°, more preferably through +/−30°.

The linear guide may comprise a bar which is connected to the central frame and on which the guide lever is mounted. The axis of the first pivot joint may coincide with the axis of the bar. In particular, a receptacle may be formed on the guide lever, said receptacle extending on both sides of the bar. The receptacle may have a guide surface, which rests on the crossbar and, during a pivoting movement of the first pivot joint, slides on the surface of the bar. The bar may be oriented in the transverse direction. The bar may extend in a straight line in a horizontal direction. The bar may have a cross-sectionally rounded contour on its top side, and in particular, the bar may be circular in cross section.

The linear guide may comprise a roller such that the movement can take place with little effort. The roller can run on the bar on which the guide lever is mounted. The roller may be mounted rotatably in a receptable of the guide lever. The surface of the roller may, at the same time, form a guide surface of the pivot joint, said guide surface sliding relative to another surface of the linear guide during a pivoting movement of the guide lever.

In particular, it is possible for the linear guide to be formed by the bar on which the guide lever is mounted. A roller arranged in the receptacle of the guide lever can roll on the bar during a movement corresponding to the linear guide. During a pivoting movement of the guide lever, the roller can execute a sliding movement about the axis of the bar.

The main direction of the guide lever may be oriented parallel to the vertical longitudinal plane. The guide lever may be rigid with respect to forces from other directions, i.e. with respect to forces that are not converted into a pivoting movement of the guide lever or a pivoting movement of the joint holder.

The mounting of the guide lever on the central frame may be arranged above the first pivot joint and/or above the second pivot joint. The cable harness is then suspended on the guide lever such that, under the influence of gravity, a stable state of the guide lever is established. The guide lever has a length between the central frame and the pivoting connections of the first and second leaf springs and a weight force exerted by the cable harness acts in a direction parallel to the length of the guide lever. The length of the guide lever may be between 10 cm and 30 cm, preferably between 15 cm and 25 cm.

The invention also relates to a multi-section vehicle, in which such a central frame system is arranged between a first car and a second car. The first car and the second car are connected together in an articulated manner via a vehicle articulation. The multi-section vehicle may be, in particular, an articulated bus, in which the central frame system is arranged between a front car and a rear car. It is also possible for the multi-section vehicle to be a tram or some other rail vehicle.

### BRIEF DESCRIPTION OF THE DRAWINGS

The invention will be described in the following text on the basis of advantageous embodiments with reference to the appended drawings, in which:

FIG. 1: shows a side view of an articulated vehicle;

FIG. 2: shows a perspective view of a central frame system of the articulated vehicle from FIG. 1;

FIG. 3: shows a view from above of a central frame system according to the invention;

FIG. 4: shows the cable guide of the central frame system from FIG. 3 in a view from above;

FIG. 5: shows a schematic illustration of a cable guide according to the invention in a view from above;

FIG. 6: shows the cable guide from FIG. 5 in view from the side;

FIG. 7: shows a perspective view of a cable guide according to the invention;

FIG. 8: shows a detail of a cable guide according to the invention in an enlarged illustration;

FIG. 9: shows the view according to FIG. 6 for an alternative embodiment of the invention.

### DETAILED DESCRIPTION

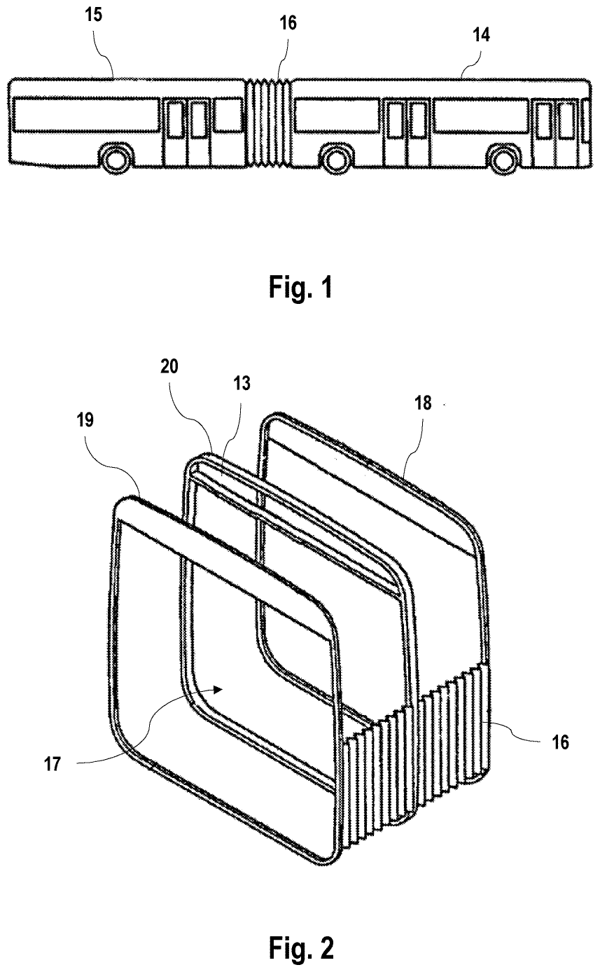

An articulated bus shown in FIG. 1 comprises a front car 14 and a rear car 15. The front car 14 and the rear car 15 are connected together via a vehicle articulation (not illustrated) such that passengers can pass between the front car 14 and the rear car 15 through a passage 17 while the bus is travelling. A bellows 16 surrounds the vehicle articulation and the passage 17. The central frame system according to the invention is arranged in the intermediate space between the front car 14 and the rear car 15 and is concealed by the bellows 16 in FIG. 1.

FIG. 2 shows the first end frame 18 of the front car 14 and the second end frame 19 of the rear car 15. The bellows 16 is shown only in part in FIG. 2. Arranged between the first end frame 18 and the second end frame 19 is a central frame 20, which is oriented in a transverse direction 26 and confers additional hold on the bellows 16.

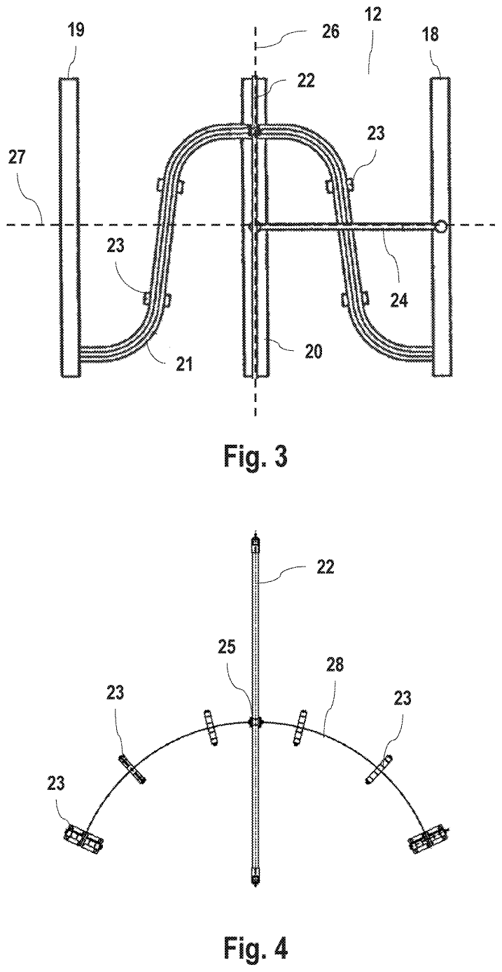

According to FIG. 3, a cable harness 21 extends between the first end frame 18 and the second end frame 19. The cable harness 21 follows a curved path, lying substantially in a horizontal plane, in the intermediate space between the front car 14 and the rear car 15. The cable harness 21 is in this way capable of compensating for movements that the front car 14 and the rear car 15 execute relative to one another. A vertical longitudinal plane 27 encloses a right angle with the transverse direction 26, i.e. with the plane of the central frame 20.

FIG. 4 illustrates the cable guide without cables. According thereto, the cable guide comprises a leaf spring 28 which is arranged centrally between the cables, is composed, according to the invention, of a first leaf spring component 29 and a second leaf spring component 30, and extends parallel to the cable harness 21. Mounted on the leaf spring 28, which is connected to a crossbar 22 of the central frame 20 in a manner described in more detail below, are supporting elements 23. According to FIG. 8, openings through which the cables of the cable harness 21 are guided are formed in the supporting elements 23. In the exemplary illustration according to FIG. 8, three cables are guided on each of the two sides of the leaf spring 28. By means of the leaf spring 28 and the supporting elements 23, the cable harness 21 is subject to defined guidance.

According to FIG. 3, the central frame 20 is connected to the first end frame 18 via a rigid steering bar 24. Formed both between the steering bar 24 and the first end frame 18 and between the steering bar 24 and the central frame 20 is an articulation, which allows pivoting movements about a vertical articulation axis. Thus, if the articulated bus travels around a bend and bends in a lateral direction, the central frame 20 can execute the corresponding pivoting movement so that it permanently takes up more or less a central position between the first end frame 18 and the second end frame 19. If, by contrast, the articulated bus travels over a brow, the corresponding pitching movement is compensated only between the central frame 20 and the second end frame 19. The distance between the first end frame 18 and the central frame 20 remains constant on account of the steering bar 24. In the event of pitching movements, the central frame 20 is thus not in a central position between the first end frame 18 and the second end frame 19.

The cable guide comprises a crossbar 22, which is arranged above an upper frame part of the central frame 20. The crossbar 22 extends in the transverse direction parallel to the central frame 20. Between the crossbar 22 and the upper frame part of the central frame 20 there remains a clearance 13, through which the cable harness 21 is guided.

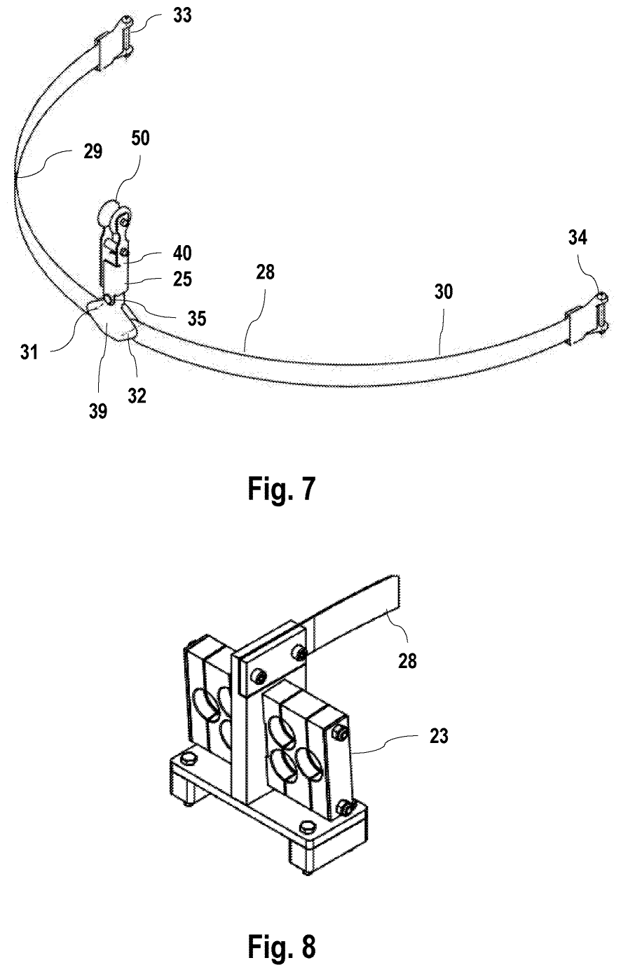

The leaf spring is mounted on the crossbar 22 via a guide lever 25, see FIGS. 6 and 7. According to FIG. 6, the guide lever 25 comprises a receptacle, in which a roller 50 is rotatably mounted. The receptacle comprises two legs, which enclose the crossbar 22 between one another. The roller 50, which is likewise enclosed between the legs, runs on the top side of the crossbar 22. The crossbar 22 is circular in cross section, and so the guide lever 25 can be pivoted about the axis of the crossbar 22. During such a pivoting movement, the roller 50 slides in the circumferential direction on the surface of the crossbar 22.

A movement of the central frame 20 in the longitudinal direction relative to the cable harness 21 is accordingly picked up by a pivoting movement of the guide lever 25 about the crossbar 22. A movement of the central frame 20 in the transverse direction relative to the cable harness 21 is picked up in that the roller 50 of the guide lever 25 runs along the crossbar 22. The cable harness 21 is held at a defined distance from the crossbar 22 by the guide lever 25.

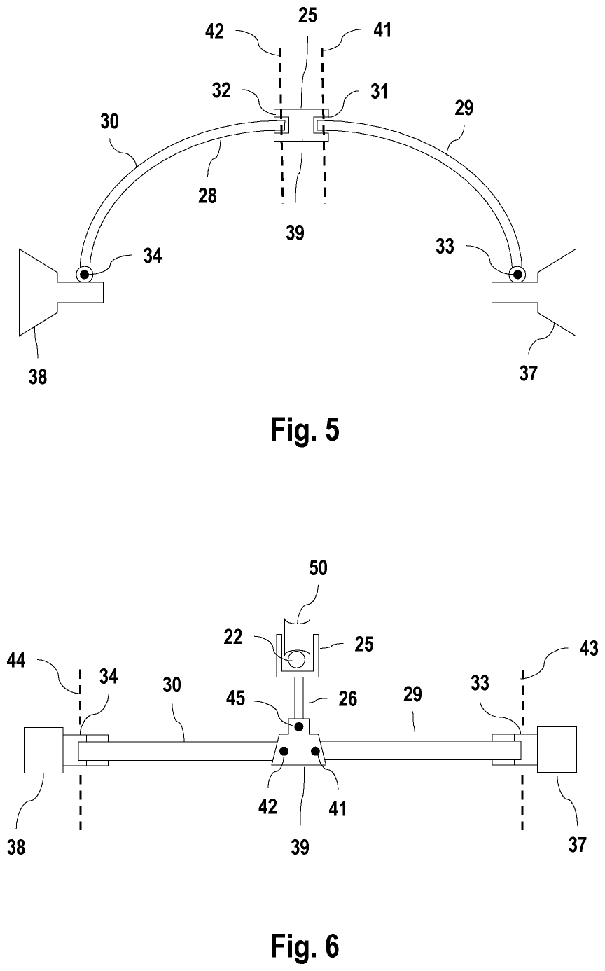

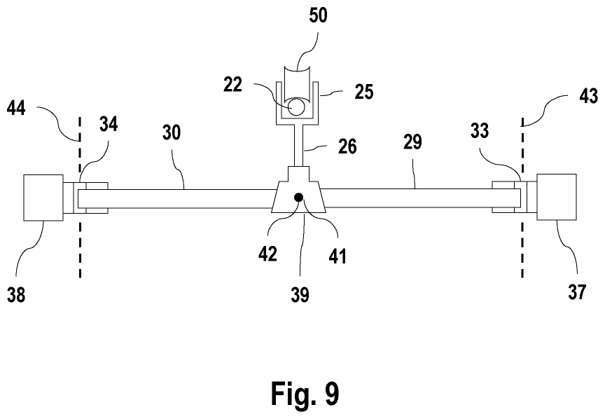

The leaf spring 28 comprises a first leaf spring component 29 and a second leaf spring component 30, see FIGS. 5 and 6. The first leaf spring component 29 extends from the guide lever 25 as far as a first bracket 37 attached to the first end frame 18. The second leaf spring component 30 extends from the guide lever 25 as far as a second bracket 28 attached to the second end frame 19. A central end of the first leaf spring component 29 and of the second leaf spring component 30, respectively, is attached to a joint holder 39 of the guide lever 25. The connection between the first leaf spring component 29 and the joint holder 39 is effected via a first pivot joint 31 with a first pivot axis 41. The connection of the second leaf spring component 30 to the joint holder 39 is effected via a second pivot joint 32 with a second pivot axis 42. The pivot axes 41, 42 are oriented parallel to one another and parallel to the crossbar 22 of the central frame 20. The vertical longitudinal plane 27 is intersected at a right angle by the pivot axes 41, 42. FIG. 6 shows an embodiment in which the first pivot axis 41 and the second pivot axis 42 are at a distance from one another. In the alternative embodiment according to FIG. 9, the first pivot axis 41 and the second pivot axis 42 are coaxial with one another.

The peripheral end of the first leaf spring component 29 is attached to the first bracket 37 via a third pivot joint 33. The peripheral end of the second leaf spring component 30 is attached to the second bracket 38 via a fourth pivot joint 34. The pivot axis 43 of the third pivot joint 33 and the pivot axis 44 of the fourth pivot joint 34 are oriented vertically, i.e. enclose a right angle with the transverse direction 26 and with the longitudinal direction. Since each of the leaf spring components 29, 30 is connected to adjacent structures via two pivot joints that are perpendicular to one another, the stresses within the leaf spring components 29, 30 are reduced, in particular during pitching movements of the articulated vehicle, compared with a leaf spring that extends as a continuous part from the first bracket 37 to the second bracket 38.

Apparent from FIG. 7: The guide lever 25 is composed of a lever part 40 and the joint holder 39. Formed between the lever part 40 and the joint holder 39 is a fifth pivot joint 35, the pivot axis 45 of which is oriented parallel to the first pivot axis 41 and to the second pivot axis 42. The fifth pivot joint 45 results in a further reduction in the mechanical stresses, because the lever part 40 can change its orientation independently of the joint holder 39.

### LIST OF REFERENCE SIGNS

Front car 14
Rear car 15
Bellows 16
Passage 17
First end frame 18
Second end frame 19
Central frame 20
Cable harness 21
Linear guide 22
Supporting element 23
Steering bar 24
Guide lever 25
Transverse direction 26
Vertical longitudinal plane 27
Leaf spring 28
First leaf spring component 29
Second leaf spring component 30
First pivot joint 31
Second pivot joint 32
Third pivot joint 33
Fourth pivot joint 34
Fifth pivot joint 35
First bracket 37
Second bracket 38
Joint holder 39
Lever part 40
First pivot axis 41
Second pivot axis 42
Third pivot axis 43
Fourth pivot axis 44
Fifth pivot axis 45
Roller 50

What is claimed:

1. A central frame system for a vehicle articulation arranged between a first car (14) and a second car (15) of a multi-section vehicle, comprising a central frame (20) oriented in a transverse direction (26) and a cable harness (21) extending between the first car (14) and the second car (15), wherein the central frame (15) surrounds a passage (17) intended for passengers and wherein the cable harness (21) is arranged above the passage (17), having a first leaf spring component (29) for holding a first portion of the cable harness (21) and having a second leaf spring component (30) for holding a second portion of the cable harness (21), wherein the first leaf spring component (29) and the second leaf spring component (30) are connected to the central frame (20) via a guide lever (25), wherein the first leaf spring component (29) is connected to the guide lever (25) via a first pivot joint (31), wherein the second leaf spring component (30) is connected to the guide lever (25) via a second pivot joint (32), and wherein the first pivot axis (41) of the first pivot joint (31) and the second pivot axis (42) of the second pivot joint (32) intersect a vertical longitudinal plane (27) of the central frame system (12).

2. The central frame system of claim 1, wherein the first leaf spring component (29) is connected to the first car (14) via a third pivot joint (33).

3. The central frame system of claim 2, wherein the third pivot axis (43) of the third pivot joint (33) has a different orientation from the first pivot axis (41).

4. The central frame system of claim 1, wherein the second leaf spring component (30) is connected to the second car (15) via a fourth pivot joint (34).

5. The central frame system of claim 4, wherein the fourth pivot axis (44) of the fourth pivot joint (34) has a different orientation from the second pivot axis (42).

6. The central frame system of claim 1, wherein the distance between a central end of the first leaf spring component (29) and a central end of the second leaf spring component (30) is less than 20 cm.

7. The central frame system of claim 1, wherein the guide lever (25) has a length between the central frame (20) and the pivoting connections (31, 32) of the first and second leaf springs and a weight force exerted by the cable harness (21) acts in a direction parallel to the length of the guide lever (25).

8. The central frame system of claim 1, wherein the guide lever (25) comprises a lever part (40) and a joint holder (39) for the first pivot joint (31) and for the second pivot joint (32), wherein the joint holder (39) is connected to the lever part (40) via a fifth pivot joint (35).

9. The central frame system of claim 8, wherein the fifth pivot axis (45) of the fifth pivot joint (35) is oriented parallel to the first pivot axis (41) and to the second pivot axis (42).

10. The central frame system of claim 1, wherein the guide lever (25) is mounted on the central frame (20) via a linear guide (22) oriented in the transverse direction (26).

11. The central frame system of claim 10, wherein the guide lever (25) is mounted pivotably on the linear guide (22).

12. A multi-section vehicle having a first car (14) and a second car (15), wherein the first car (14) and the second car (15) are connected together in an articulated manner via a vehicle articulation, comprising a central frame system (12) arranged between the first car (14) and the second car (15), wherein the central frame system (12) is configured according to claim 1.
